(19) United States
(12) Patent Application Publication
(10) Pub. No.: US 2022/0018674 A1
(43) Pub. Date: Jan. 20, 2022

(54) METHOD, APPARATUS, AND SYSTEM FOR PROVIDING TRANSPORTION LOGISTICS BASED ON ESTIMATED TIME OF ARRIVAL CALCULATION

(71) Applicant: HERE Global B.V., Eindhoven (NL)

(72) Inventors: Jingwei XU, Chicago, IL (US); Yuxin GUAN, Chicago, IL (US); Bruce BERNHARDT, Chicago, IL (US); Weimin HUANG, Chicago, IL (US)

(21) Appl. No.: 17/374,602

(22) Filed: Jul. 13, 2021

Related U.S. Application Data
(60) Provisional application No. 63/051,688, filed on Jul. 14, 2020.

(51) Int. Cl. G01C 21/34; G01C 21/36; G06Q 10/08

(52) U.S. Cl. CPC G01C 21/3492; G06Q 10/08355; G01C 21/3691

(57) ABSTRACT

An approach is provided for providing a recommended route and departure time combination based on real-time estimated times of arrival (ETAs). The approach, for example, involves determining a plurality of candidate routes between an origin and at least one destination. The approach also involves retrieving real-time information, historical information, predicted information, or a combination thereof associated with the origin, the destination, the plurality of candidate routes, or a combination thereof. The approach further involves calculating respective cost values (e.g., ETAs) for traveling for the plurality of candidate routes at a plurality of different departure times. The respective cost values are based on the real-time information, the historical information, the predicted information, or a combination thereof. The approach further involves determining a recommended route and departure time combination based on the respective cost values. The approach further involves providing the recommended route and departure time combination as an output.

### RELATED APPLICATION

This application claims priority to U.S. Provisional Patent Application Ser. No. 63/051,688, filed Jul. 14, 2020, entitled “METHOD, APPARATUS, AND SYSTEM FOR PROVIDING TRANSPORTION LOGISTICS BASED ON ESTIMATED TIME OF ARRIVAL CALCULATION”, which is incorporated herein by reference in its entirety.

### BACKGROUND

Product transportation logistics services often require meeting customer delivery demands while minimizing related costs (e.g., time, distance, fuel, etc.). However, to select optimal routes to cover all deliveries and pickups of a fleet of vehicles to and from numerous customer sites within time restraints and other customer requirements is extremely complex and difficult. Such logistics relies on accurate calculation of estimated times of arrival (ETAs). However, the existing logistics often execute without any dynamic ETA updates while a dispatched vehicle is already driving in the field. Accordingly, logistics service providers face significant technical challenges to provide updated ETA calculation considering real-time traffic flow and incident information, recurring congestion incident information, etc.

### Some Example Embodiments

Therefore, there is a need for providing transportation dispatching using real-time estimated time of arrival (ETA) updates.

According to one embodiment, a method comprises determining a plurality of candidate routes between an origin and at least one destination. The method also comprises retrieving real-time information, historical information, predicted information, or a combination thereof associated with the origin, the destination, the plurality of candidate routes, or a combination thereof. The method further comprises calculating respective cost values (e.g., estimated times of arrival) for traveling for the plurality of candidate routes at a plurality of different departure times. The respective cost values are based on the real-time information, the historical information, the predicted information, or a combination thereof. The method further comprises determining a recommended route and departure time combination based on the respective cost values. The method further comprises providing the recommended route and departure time combination as an output.

According to another embodiment, an apparatus comprises at least one processor, and at least one memory including computer program code for one or more computer programs, the at least one memory and the computer program code configured to, with the at least one processor, cause, at least in part, the apparatus to determine a plurality of candidate routes between an origin and at least one destination. The apparatus is also caused to retrieve real-time information, historical information, predicted information, or a combination thereof associated with the origin, the destination, the plurality of candidate routes, or a combination thereof. The apparatus is further caused to calculate respective cost values (e.g., estimated times of arrival) for traveling for the plurality of candidate routes at a plurality of different departure times. The respective cost values are based on the real-time information, the historical information, the predicted information, or a combination thereof. The apparatus is further caused to determine a recommended route and departure time combination based on the respective cost values. The apparatus is further caused to provide the recommended route and departure time combination as an output.

According to another embodiment, a computer-readable storage medium carries one or more sequences of one or more instructions which, when executed by one or more processors, cause, at least in part, an apparatus to determine a plurality of candidate routes between an origin and at least one destination. The apparatus is also caused to retrieve real-time information, historical information, predicted information, or a combination thereof associated with the origin, the destination, the plurality of candidate routes, or a combination thereof. The apparatus is further caused to calculate respective cost values (e.g., estimated times of arrival) for traveling for the plurality of candidate routes at a plurality of different departure times. The respective cost values are based on the real-time information, the historical information, the predicted information, or a combination thereof. The apparatus is further caused to determine a recommended route and departure time combination based on the respective cost values. The apparatus is further caused to provide the recommended route and departure time combination as an output.

According to another embodiment, an apparatus comprises means for determining a plurality of candidate routes between an origin and at least one destination. The apparatus also comprises means for retrieving real-time information, historical information, predicted information, or a combination thereof associated with the origin, the destination, the plurality of candidate routes, or a combination thereof. The apparatus further comprises means for calculating respective cost values (e.g., estimated times of arrival) for traveling for the plurality of candidate routes at a plurality of different departure times. The respective cost values are based on the real-time information, the historical information, the predicted information, or a combination thereof. The apparatus further comprises means for determining a recommended route and departure time combination based on the respective cost values. The apparatus further comprises means for providing the recommended route and departure time combination as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing an estimated time of arrival (ETA) with a uncertain starting location, according to one embodiment;

FIG. 2 is a diagram of an example process for providing a recommended route and departure time combination based on real-time estimated times of arrival, according to one embodiment;

FIG. 3 is a diagram of components of a transportation logistics platform capable of providing a recommended route and departure time combination based on real-time estimated times of arrival, according to one embodiment;

FIG. 4 is a flowchart of a process for providing a recommended route and departure time combination based on real-time estimated times of arrival, according to one embodiment;

FIG. 5 is a data input diagram of an ETA calculation engine capable of providing real-time estimated time of arrival updates, according to one embodiment;

FIG. 6 is a is a diagram of an example recurring congestion, according to one embodiment;

FIG. 7 is a is a diagram of an example tail growing congestion event, according to one embodiment;

FIG. 8 is an example traffic light signal phase and timing (SPaT) histogram, according to one embodiment;

FIG. 9 is a diagram of an example user interface depicting a recommended route and departure time combination, according to one embodiment;

FIG. 10 is a diagram of a geographic database, according to one embodiment;

FIG. 11 is a diagram of hardware that can be used to implement an embodiment;

FIG. 12 is a diagram of a chip set that can be used to implement an embodiment; and

FIG. 13 is a diagram of a mobile terminal (e.g., handset or vehicle or part thereof) that can be used to implement an embodiment.

### DESCRIPTION OF SOME EMBODIMENTS

Examples of a method, apparatus, and computer program for providing a recommended route and departure time combination based on real-time estimated times of arrival are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

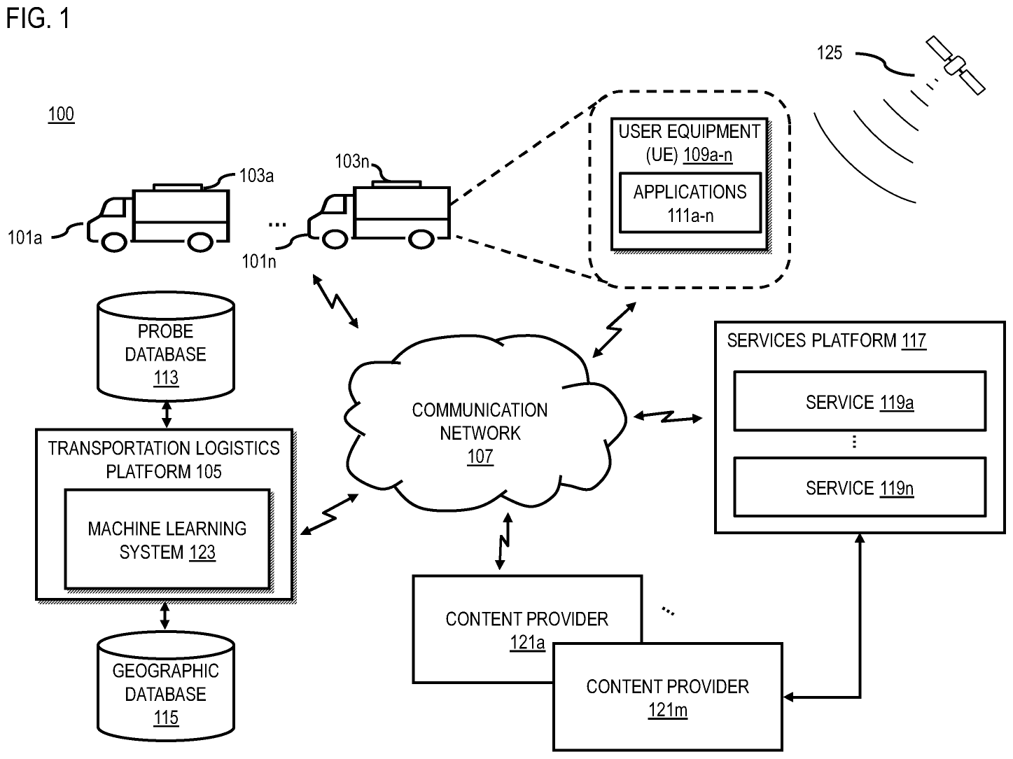

FIG. 1 is a diagram of a system capable of providing a recommended route and departure time combination based on real-time estimated times of arrival (ETAs), according to one embodiment. Travel time is a basic attribute considered by various transportation logistics services, such as product delivery, etc. The users of the transportation logistics services make dispatching decisions based on cost considerations including ETAs to meet various delivery requirements (e.g., time restraints).

It is straightforward to calculate an ETA of one route using a travel time for each road segment of the route and a transition time between two connecting road segments. However, due to the complexity of traffic conditions, it is well known in industry that ETA estimation is challenging since it requires the pre-knowledge of traffic information of each road segment while the traffic situation changes dynamically along the route. Factors contributing to ETA calculation include but not limited to traffic flows, congestion incidents, weather conditions, traffic lights signal phase and timing, . . . etc.

To address these problems, the system 100 of FIG. 1 introduces a capability to provide a recommended route and departure time combination based on real-time estimated times of arrival, given an origin and at least one destination. In one embodiment, the system 100 can build a route selection system with an ETA calculation engine by taking account the real-time flow and incident information, recurring traffic congestion pattern, weather information, scheduled road works and construction information along with traffic light signal phase and timing (SPaT) information, thereby estimating travel time and a departure time combinations for routing services. In addition, the system 100 can determine a recommended route and departure time combination based on the respective cost values in order to reach the at least one destination before a respective established time.

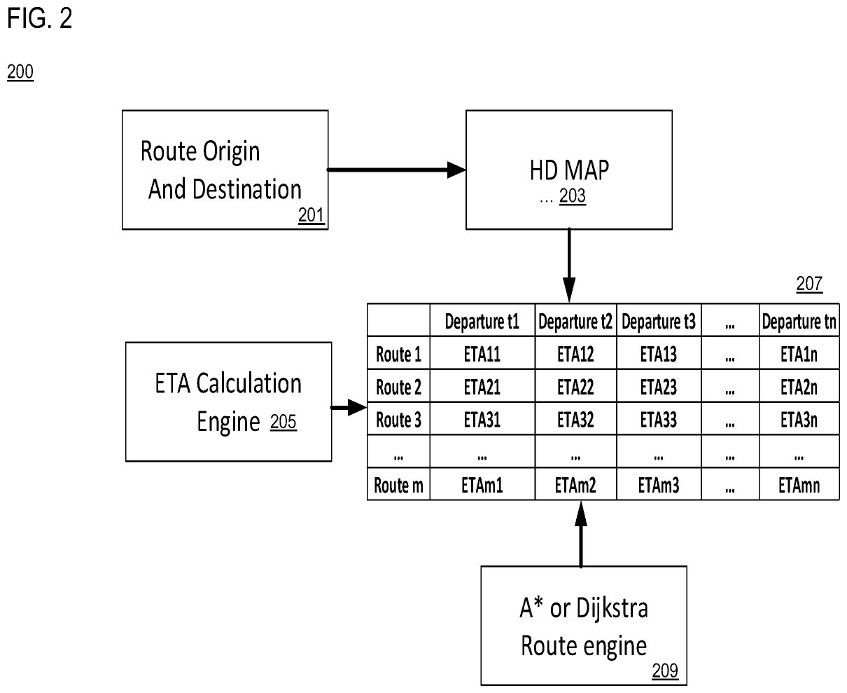

FIG. 2 is a diagram of an example use case for providing a recommended route and departure time combination based on real-time estimated times of arrival, according to one embodiment. The system 100 can then retrieve data 201 of a given origin and at least one destination. Optionally, the system 100 can retrieve one or more delivery time requirements. The system 100 can retrieve the available real-time, historical, and prediction information, such as high definition (HD) map data 203, traffic real-time flow, traffic real-time incident information, road closure and construction information, traffic light SPaT information, recurring congestion information, traffic historical pattern information, unpredictable event information, weather information, etc. Based on the information, an ETA calculation engine 205 of the system 100 can generate a transportation logistics delivery route table 207 with each row representing different routes (e.g., Route 1-Route m), each column representing different departure delta times (e.g., Departure t1-Departure tn), and calculated ETAs as the values (e.g., ETA11-ETAmn). The ETA calculation engine 205 can calculate an ETA for all combinations of each route and each departure time, and a route selection engine 209 use a graph traversal and path search algorithm (e.g., A* algorithm, Dijkstra algorithm, etc.) to determine the best route and departure time combination.

The system 100 can improve the transposition logistics service in various use cases where various traffic affecting events (e.g., traffic congestion, road works, traffic lights, weather, etc.) can happen. As such, the system 100 can update the ETA calculation due to the traffic affecting events that occur when the vehicle is on the road, thereby recommending a best route and departure time combination based on the traffic affecting events in a real-time or substantially real-time manner. The system 100 can be used in handling many route optimization applications, such as product/package delivery, trip planning (e.g., grocery shopping, sightseeing, etc.), ridesharing (e.g., airport shuttles, school buses, etc.), etc., for example, to provide the route and departure time recommendations to the drivers and/or riders, so the users will have better expectation based on dynamic ETA updates.

In one embodiment, the system 100 collects a plurality of instances of probe data and/or vehicle sensor data from one or more vehicles 101a-101n (also collectively referred to as vehicles 101) (e.g., autonomous vehicles, HAD vehicles, semi-autonomous vehicles, etc.) having one or more vehicle sensors 103a-103n (also collectively referred to as vehicle sensors 103) (e.g., global positioning system (GPS), LiDAR, camera sensor, etc.) and having connectivity to a transportation logistics platform 105 via a communication network 107. In one instance, the real-time probe data may be reported as probe points, which are individual data records collected at a point in time that records telemetry data for that point in time. A probe point can include attributes such as: (1) probe ID, (2) longitude, (3) latitude, (4) heading, (5) speed, and (6) time.

In one instance, the system 100 can also collect the real-time probe data and/or sensor data from one or more user equipment (UE) 109a-109n (also collectively referenced to herein as UEs 109) associated with the a vehicle 101 (e.g., an embedded navigation system), a user or a passenger of a vehicle 101 (e.g., a mobile device, a smartphone, etc.), or a combination thereof. In one instance, the UEs 109 may include one or more applications 111a-111n (also collectively referred to herein as applications 111) (e.g., a navigation or mapping application). In one embodiment, the probe data and/or sensor data collected may be stored in the probe database 113, the geographic database 115, or a combination thereof.

In one instance, the system 100 may also collect real-time probe data and/or sensor data from one or more other sources such as government/municipality agencies, local or community agencies (e.g., a police department), and/or third-party official/semi-official sources (e.g., a services platform 117, one or more services 119a-119n, one or more content providers 121a-121m, etc.).

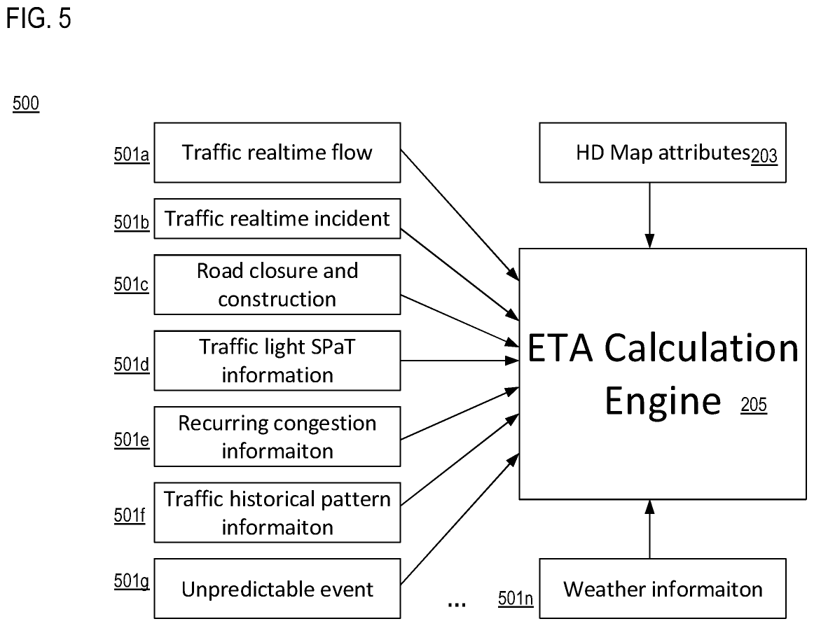

In this embodiment, vehicle 101 can be configured to report probe data and/or sensor data (e.g., via a vehicle sensor 103, a UE 109, or a combination thereof) as probe points, which are individual data records collected at a point in time that records telemetry data for the vehicle 101 for that point in time. In another embodiment, the probe data and/or sensor data is received from one or more third party probe data aggregators, the probe database 113, or a combination thereof. In one embodiment, a probe point may include the following six attributes (by way of illustration and not limitation): (1) probe ID; (2) longitude; (3) latitude; (4) speed; (5) bearing; and (6) time. In one embodiment, the traffic affecting event/condition data (later discussed with respect to FIG. 5) is received directly from the vehicle 101. In another embodiment, the traffic affecting event/condition data is received from one or more third party data aggregators, the geographic database 115, or a combination thereof.

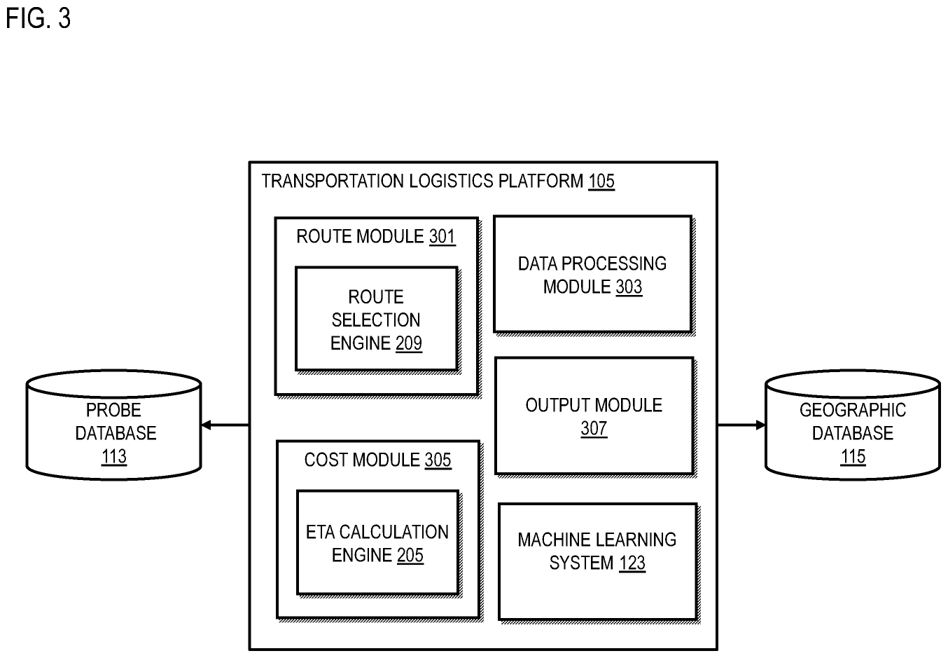

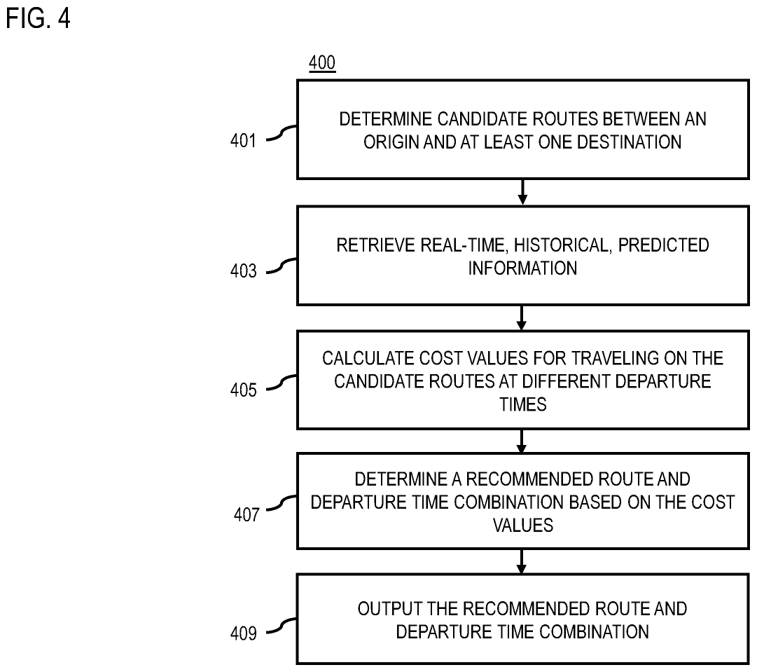

FIG. 3 is a diagram of the components of the transportation logistics platform 105, according to one embodiment. By way of example, the transportation logistics platform 105 includes one or more components for providing a recommended route and departure time combination based on real-time estimated times of arrival, according to the various embodiments described herein. It is contemplated that the functions of these components may be combined or performed by other components of equivalent functionality. In one embodiment, the transportation logistics platform 105 includes a route module 301, a data processing module 303, a cost module 305, an output module 307, and a machine learning system 123 has connectivity to the probe database 113 and the geographic database 115. The above presented modules and components of the transportation logistics platform 105 can be implemented in hardware, firmware, software, or a combination thereof. Though depicted as a separate entity in FIG. 1, it is contemplated that the transportation logistics platform 105 may be implemented as a module of any other component of the system 100. In another embodiment, the transportation logistics platform 105, the machine learning system 123, and/or the modules 301-307 may be implemented as a cloud-based service, local service, native application, or combination thereof. The functions of the transportation logistics platform 105, the machine learning system 123, and/or the modules 301-307 are discussed with respect to FIG. 4.

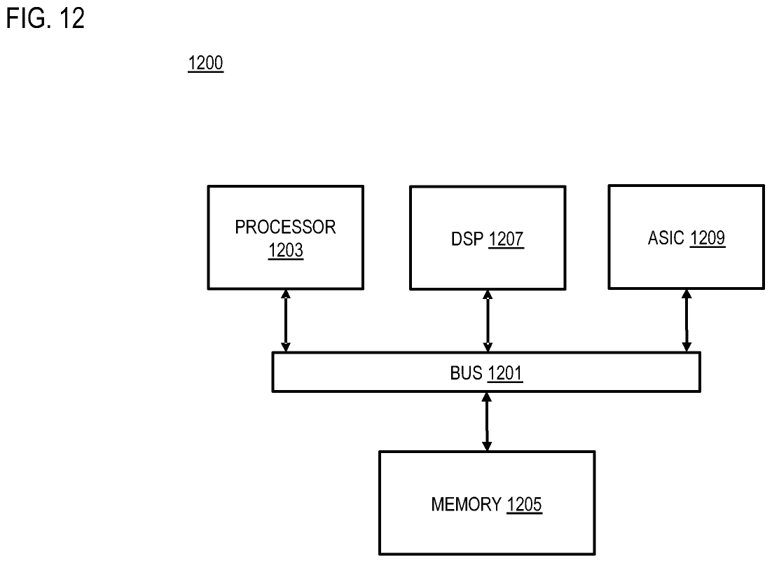

FIG. 4 is a flowchart of a process for providing a recommended route and departure time combination based on real-time estimated times of arrival, according to one embodiment. In various embodiments, the transportation logistics platform 105, the machine learning system 123, and/or any of the modules 301-307 may perform one or more portions of the process 400 and may be implemented in, for instance, a chip set including a processor and a memory as shown in FIG. 12. As such, the transportation logistics platform 105 and/or the modules 301-307 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In one embodiment, the route module 301 can map-match the probe data and/or sensor data to identify which road, path, link, etc. a probe device (e.g., a vehicle 101, a UE 109, etc.) is traveling. The map matching process, for example, enables the route module 301 to correlate each location data point of a vehicle 101 to a corresponding location on a segment of the road network. The identified route data can be stored in the geographic database 115.

In step 401, the route module 301 can determine a plurality of candidate routes between an origin and at least one destination. In order to determine the candidate routes between an origin and at least one destination, the route module 301 can use a real data set and road networks from a geographic database (e.g., the geographic database 115), which may consist of 16 nodes and 57 links, for example. Referring back to FIG. 2, each input OD set can be assigned with multiple routes based on the HD map data 203 and a plurality departure time slots. The HD map data 203 can be retrieved locally or from the geographic database 115.

In one embodiment, the plurality of candidate routes relates to transportation logistics. For example, the origin and the at least one destination are provided by a user of the system 100 (e.g., a customer of a transportation logistics service, such as package delivery, food delivery, product delivery, fleet management, etc.). In another embodiment, the plurality of candidate routes relates to tourism logistics (e.g., transport tourists to one or more destinations). In yet another embodiment, the plurality of candidate routes relates to commuting logistics (e.g., school buses logistics, company shuttle logistics, etc.).

In one use case, the user provides one origin and one destination for the system 100 to determine one optimal route and a departure time combination for one vehicle. In this case, the route module 301 determines all candidate routes between the origin and the destination to facilitate the steps 403-409.

In another use case, the user provides one origin and multiple destinations for the system 100 to determine an optimal multi-stop route and respective departure times from the origin and from intermediate destinations (i.e., stops) for one vehicle. In this case, the route module 301 determines all candidate routes between the origin and the final destination, and filters the candidate routes that pass through the stops to facilitate the steps 403-409.

In yet another use case, the user provides an origin and destinations of multiple vehicles for the system 100 to determine an optimal route and a departure time combination for each vehicle starting from the origin (i.e., one destination per vehicle). In this case, the route module 301 determines all candidate routes between the origin and a respective destination per vehicle to facilitate the steps 403-409.

In yet another use case, the user provides an origin and a plurality of destinations of multiple vehicles for the system 100 to determine an optimal route and a departure time combination for each vehicle starting from the origin and respective destinations (i.e., multiple destinations for different vehicles). In one embodiment, the route module 301 clusters the destinations into the same number of groups as the number of vehicles (e.g., 10) based on their relative proximity, then processes each group as a multi-stop route use case. For each clustered group of destinations, the route module 301 determines all candidate routes between the origin and the final destination of the group, and filters the candidate routes that pass through the stops of the group to facilitate the steps 403-409.

In step 403, the data processing module 303 can retrieve real-time information, historical information, predicted information, or a combination thereof associated with the origin, the destination, the plurality of candidate routes, or a combination thereof. In one embodiment, the real-time information, the historical information, the predicted information, or a combination thereof relate to high-definition digital map data with lane-level accuracy.

Alternatively or concurrently, the real-time information, the historical information, the predicted information, or a combination thereof relate to recurring congestion data, developing congestion data, predicted congestion data, or a combination.

Alternatively or concurrently, the real-time information, the historical information, the predicted information, or a combination thereof include traffic light signal phase and timing (SPaT) data.

Alternatively or concurrently, the real-time information, the historical information, the predicted information, or a combination thereof relate to traffic real-time flow information, traffic real-time incident information, road closure and construction information, traffic historical pattern information, unpredictable event information, weather information, etc.

In step 405, the cost module 305 can calculate respective cost values for traveling for the plurality of candidate routes at a plurality of different departure times. In one embodiment, the respective cost values are based on the real-time information, the historical information, the predicted information, or a combination thereof retried in step 403. In one embodiment, the respective cost values include an estimated time of arrival (ETA) at the at least one destination as determined by the ETA calculation engine 205. Referring back to FIG. 2, the ETA calculation engine 205 can calculate, for each input OD set, an ETA is generated and put into the transportation logistics delivery route table 207. In another embodiment, the departure times in the table 207 can be replaced with arrival times that can be back calculated into delivery times. For instance, the arrival times meet customer deadline requirements, and provide drivers' references to the deadline requirements.

In one embodiment, the ETA calculation engine 205 can perform ETA estimation using a route based approach according to this formula:

ETAᵣₒᵤₜₑ=Σᵢ₌₁ⁿ+tₗᵢₙₖⁱ+tₜᵣₐₙₛᵢₜᵢₒₙ^{i,i+1} (1)

tₗᵢₙₖⁱ: estimated travel time on link i using the traffic information

tₜᵣₐₙₛᵢₜᵢₒₙ^{i,i+1}: transition cost from link i to link i+1

As mentioned, the ETA calculation engine 205 can calculate a travel time tₗᵢₙₖⁱ for each road link i and a transition time tₜᵣₐₙₛᵢₜᵢₒₙ^{i,i+1} between two adjacent road links i and i+1, factoring in various traffic affecting events/conditions as discussed below. FIG. 5 is a data input diagram of the ETA calculation engine 205 capable of providing real-time estimated time of arrival updates using HD map attributes 203 in conjunction with traffic affecting events/conditions 800, according to one embodiment. The traffic affecting events/conditions 501 may include traffic real-time flow 501a, traffic real-time incident information 501b, road closure and construction information 501c, traffic light signal phase and timing (SPaT) information 501d, recurring congestion information 501d, traffic historical pattern information 501f, unpredictable event information 501g, . . . , weather information 501n, etc.

In one embodiment, the ETA calculation engine 205 can factor in the Equation (1) a number of different traffic affecting events/conditions to estimate vehicle in-segment speeds, thereby computing their ETAs. By way of example, the ETA calculation engine 205 can calculate a travel time ETAᵣₒᵤₜₑ using traffic affecting events/conditions parameters each that describes one traffic affecting event/condition on one road segment/link thereby aggregating travel times of all segments of a route from an origin “O” to a destination “D” using the Equation (1).

In one embodiment, for each road segment i, e.g., a road link or a traffic message channel (TMC) location line, the ETA calculation engine 205 can use respective HD map attributes 203 to describe the segment in Equation (1), such as a road functional class (e.g., arterial, collector, local, etc.), a length, a speed limit, other road attributes (e.g., topology, geometry, etc.), lane information (e.g., left turn, sharp left turn, right turn, sharp right turn, straight, etc.), etc. The more detailed these HD map attributes are used to define the road segment/link, the more accurate ETAs can be calculated.

The HD map data 203 can provide information on physical capacity of roadways, i.e., the maximum amount of traffic capable of being handled by a given road segment. Capacity is determined by a number of factors: the number and width of lanes and shoulders, merge areas at interchanges, roadway alignment (grades and curves), etc. In addition, toll booths may cause bottlenecks because they restrict the physical flow of traffic.

In another embodiment, the HD map data 203 can include live HD map data retrieved from a cloud-based HD map service to provide more accurate vehicle location and speed data and to support highly automated driving for the vehicle 101. The live vehicle location and speed data can be applied directly in ETA calculation.

The live HD map data can be composed of tiled mapping layers that provide access to accurate geometry and robust attributes of a road network. The layers may be grouped into the following models. A road centerline model provides road topology (specified as nodes and links in a graph), shape geometry, and other road-level attributes. A HD lane model that provides lane topology (as lane groups and lane group connectors), highly accurate geometry, and lane-level attributes. A HD localization model provides features to support vehicle localization strategies.

In one embodiment, the traffic real-time flow information 501a can include real-time traffic flow estimation data from a traffic processing engine, one or more traffic data aggregators, and/or one or more navigation service providers. The real-time traffic data can be aggregated and analyzed from a mix of sources to reflect real-world road conditions. Sources may include probe data, fixed sensors, government sources, billions of historical traffic records, and third party data.

In one embodiment, the traffic real-time incident information 501b can include real-time traffic incident data from a traffic incident processing engine, one or more traffic incident data aggregators, and/or one or more navigation service providers. A traffic real-time incident can be an event that disrupts the normal flow of traffic, usually by physical impedance in the travel lanes. The most common form of incidents that block travel lanes physically include vehicular crashes, breakdowns, and debris in travel lanes, etc. In addition, events that occur on the shoulder or roadside can also influence traffic flow by distracting drivers, leading to changes in driver behavior and ultimately degrading the quality of traffic flow. Incidents from the roadway (a fire in a building next to a highway) can also be considered as traffic incidents when they affect travel in the travel lanes.

In one embodiment, the road closure and construction information 501c can include scheduled road closure and construction information. Construction activities on the roadway can result in physical changes to the highway environment. These changes may include a reduction in the number or width of travel lanes, lane “shifts,” lane diversions, reduction, or elimination of shoulders. Temporary roadway closures and work zones usually cause traffic delays.

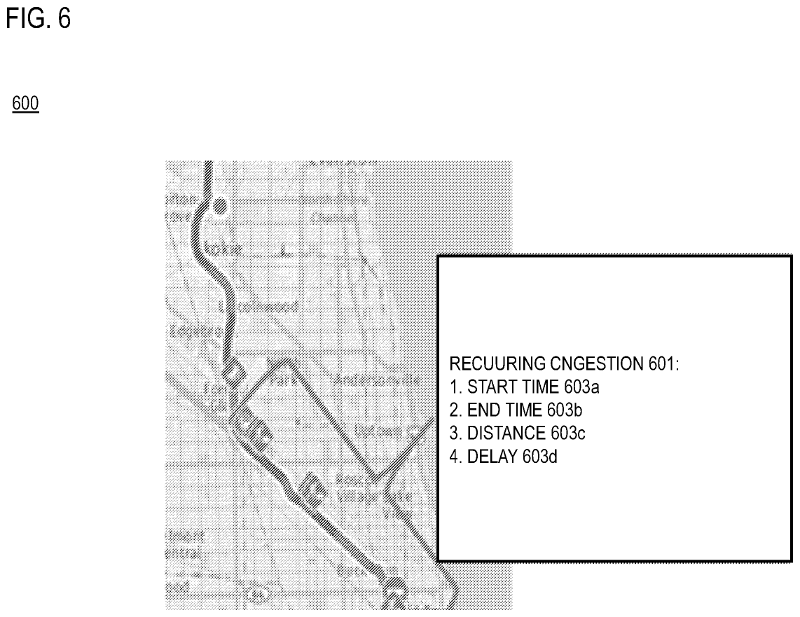

In one embodiment, the recurring congestion information 501e can include recurring congestion statistical data (daily or weekly) on one or more road segments, such as a congestion start time, a congestion end time, and delay times. In one embodiment, recurring congestion information is used to provide a better ETA estimation on highway road segments. FIG. 6 is a is a diagram 600 of an example recurring congestion 601, according to one embodiment. By way of example, FIG. 6 shows a recurring congestion example near city downtown. With enough data samples, the data processing module 303 can determine a statistical start time 603a, an end time 603b, a distance 603c, and delay time data 603d of a recurring congestion to provide to the ETA calculation engine 205 as heuristic knowledge for ETA estimation, when an OD route crossing such recurring congestion.

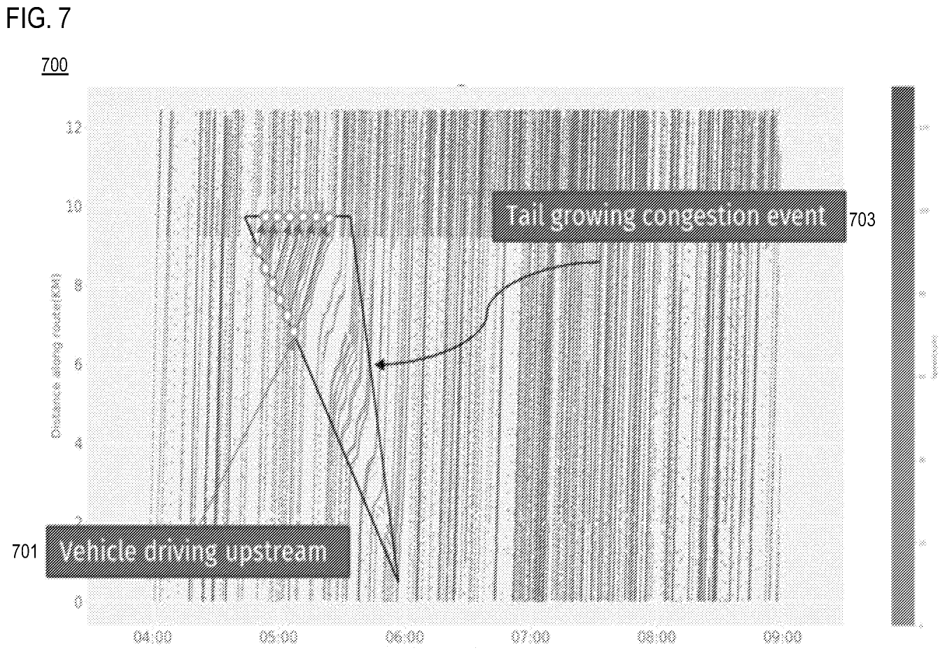

Congestion “incident” or “flow” can be described as excess vehicles on a road segment, with stop, or stop and go traffic. in general, there are difference resources may cause the congestion. Accurate modeling these different kind of congestion incidents in different regions can increase ETA estimation accuracy. By way of example, the three-phase traffic theory breaks physics of traffic congestion into three phases of traffic: free flow (F), synchronized flow (S), and wide moving jam (WMJ). FIG. 7 is a is a diagram 700 of an example tail growing congestion event, according to one embodiment. The diagram 700 shows travel time on x-axis and a travel distance along a route in km on y-axis. The diagram 700 also shows a point 701 marking a vehicle 101 driving upstream, a tail growing congestion event 703 with a slope (i.e., a congestion tail growing speed) to be calculated and then used to determine when the vehicle 101 can hit a tail of the congestion event thereby further improving ETA accuracy.

In one embodiment, the traffic light SPaT information 501d can include traffic light SPaT information for each road segment. In one embodiment, where traffic lights exist on routes such as arterial roads, the delay due to traffic light timing can play a major role in ETA estimation. Traffic lights cause intermittent disruption of traffic flow such as road crossings, railroad crossings, etc. In addition, poorly timed traffic signals contribute to congestion and travel time variability.

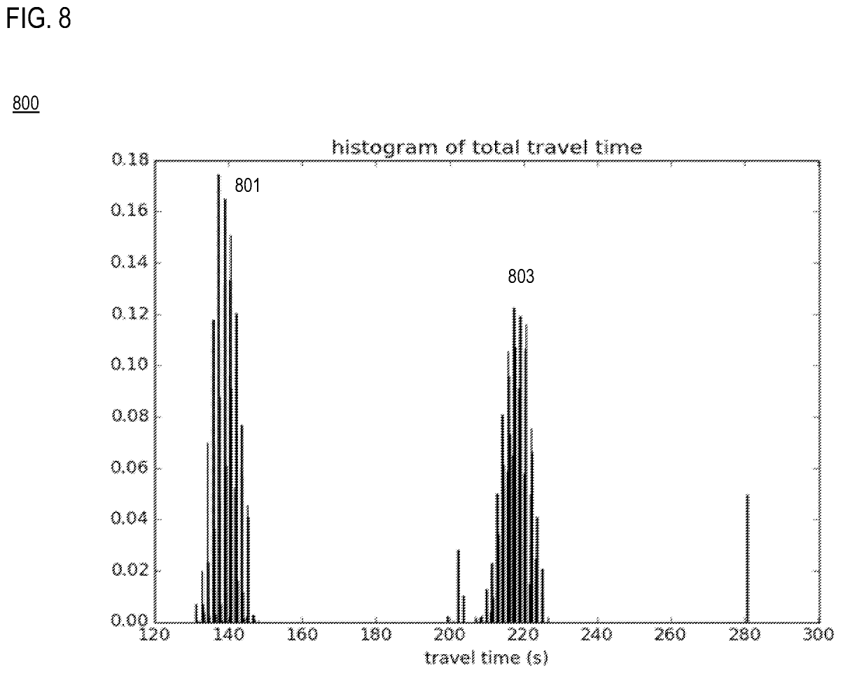

FIG. 8 is an example traffic light SPaT histogram 800, according to one embodiment. The histogram 800 shows total travel time in seconds on x-axis, and the respective probability on y-axis. The histogram 800 also shows two clusters of travel delay time models for a given route. The first cluster model 801 (with a travel delay time mean around 140 s) shows no red light impact, while the second cluster model 803 (with a travel delay time mean around 220 s) shows a ˜80 seconds red light cycle impact. Given the average driving speed along the route with multiple traffic light signals along with available traffic light SPaT information, an average number of yellow-light and red-light signal delay impacts could be estimated by the data processing module 303. The delay time data could be factored into the equation (1) for the ETA calculation engine 205 to improved ETA estimation.

In one embodiment, the traffic historical pattern information 501f can include one or more historical traffic speed values for each road segment. Day-to-day variability in traffic demand leads to some hours/days with higher traffic volumes than others. Varying demand volumes superimposed on a road network with fixed capacity also results in variable (i.e., unreliable) travel times, even without any traffic incidents.

In one embodiment, the unpredictable event information 501g can include historical accident information, animal found on the road event data, terrorist attack event data, . . . etc. associated to a road segment to be used in a travel time delay model for ETA calculation. The travel time delay model can be built via the machine learning system 123 as discussed later. In one embodiment, a unpredictable event is a special event causing traffic demand fluctuations where traffic flow in the vicinity of the event will be radically different from “typical” patterns. Special events occasionally cause “surges” in traffic demand that overwhelm the road network.

In one embodiment, the weather information 501n can include weather prediction information that can affect road travel along a dispatching OD (origin to destination) route in a certain time period. Environmental conditions, such as weather conditions, can lead to changes in driver behavior that affect traffic flow. For example, drivers usually drive at lower speeds and increase their headways when visibility is reduced, such as by precipitation, bright sunlight on the horizon, fog, or smoke. Wet, snowy, or icy roadway surface conditions also lead to the same effect on driver behaviors.

In one embodiment, driver road familiarity is factored in ETA calculation. Research has shown that drivers familiar with routinely congested roadways space themselves closer together than drivers less familiar with the roadway on the congested roadways. These behaviors lead to an increase in the amount of traffic that can be handled.

In step 407, the route selection engine 209 in the route module 301 can determine a recommended route and departure time combination based on the respective cost values. In one embodiment, the recommended route and departure time combination is selected based on selecting a minimum cost value from the respective cost values. Referring back to FIG. 2, the route selection engine 209 then uses A* algorithm, Dijkstra algorithm, or equivalent to determine the optimal route and departure time combination. By way of example, the recommended route and departure time combination can have the shortest ETA, the shortest distance, the lowest fuel cost, etc.

In one embodiment, the data processing module 303 can retrieve a delivery time requirement (e.g., for the customer of the transportation logistics service), for the route selection engine 209 to determine the recommended route and departure time combination further based on the delivery time requirement. Such delivery time requirement may be a specified deadline, time window, etc. to be applied as a constraint on the plurality of departure times, the respective cost function values (e.g., ETAs), or a combination thereof. The plurality of departure times can be spaces per every 15 minutes, 30 minutes, 1 hour, 2 hours, etc. depending on customer demands, fleet size, traffic, etc.

In another embodiment, as the data processing module 303 monitors the real-time information, the cost module 305 can update the respective cost values based on the real-time information for the route selection engine 209 to determine an updated recommended route and departure time combination.

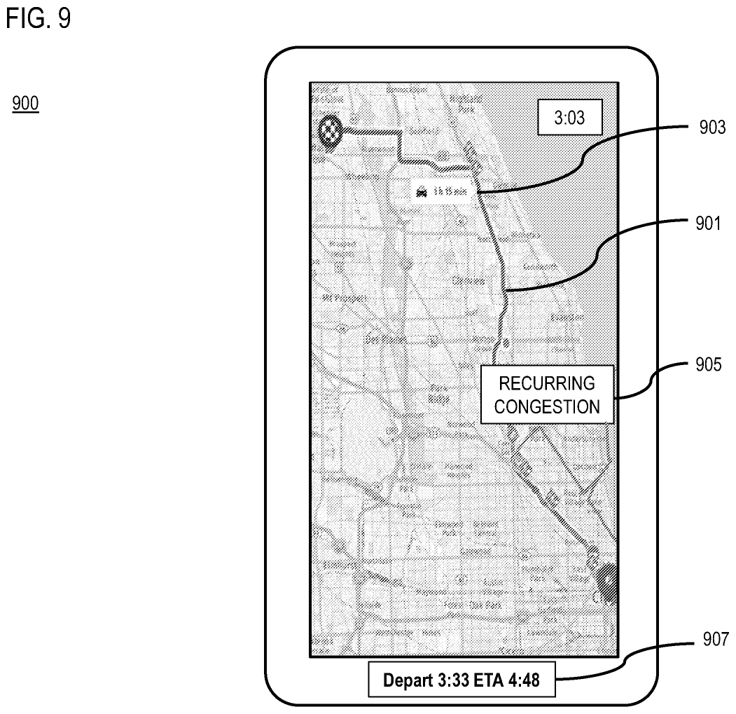

In one embodiment, the recommended route and departure time combination includes a recommended departure delay (later discussed with respect to FIG. 9). Due to the various traffic affecting events/conditions, the route selection engine 209 can recommend the vehicle 101 to start later, wait in a rest area, etc. to avoid delay caused by the respective traffic affecting events/conditions. By way of example, due to a major highway traffic accident happened on the route, the route selection engine 209 recommends delaying a travel starting time from 8 am to 10 am to save a total travel time.

In one embodiment, respective probabilities of the traffic affecting events/conditions 501 can be determined using machine learning (e.g., a support vector machine (SVM), neural network, decision tree, k-nearest neighbors matching, etc.). Referring back to FIG. 5, the traffic affecting events/conditions 501 may include traffic real-time flow 501a, traffic real-time incident information 501b, road closure and construction information 501c, traffic light signal phase and timing (SPaT) information 501d, recurring congestion information 501d, traffic historical pattern information 501f, unpredictable event information 501g, . . . , weather information 501n, etc.

In one embodiment, the traffic time delay model can be built via machine learning based on the respective probabilities of the traffic affecting events/conditions 501. By way of example, the machine learning system 123 can calculate travel time using parameters that describe a distribution or a set of distributions of these traffic affecting events/conditions 501 one road segments, thereby calculating ETA of a route from an origin “O” to a destination “D”.

In another embodiment, the machine learning system 123 can build the traffic time delay model via machine learning (e.g., a support vector machine (SVM), neural network, decision tree, smoothing heuristic, etc.) using a trajectory-based model to estimate vehicle in-segment speeds, thereby computing their ETAs. Since the number and diversity of these traffic affecting events/conditions are uncertain, the machine learning system 123 can calculate travel time using parameters that describe a distribution or a set of distributions of traffic flows on a road segment, thereby calculating ETA of a route from an origin “O” to a destination “D”.

In yet another embodiment, the route selection engine 209 can determine the recommended route and departure time combination based on machine learning, and such machine learning route model accepts the respective cost values (e.g., ETAs) as at least one input feature. In one embodiment, the machine learning system 123 can select respective weights of the traffic affecting events/conditions 501. In another embodiment, the machine learning system 123 can further select or assign respective correlations, relationships, etc. among the traffic affecting events/conditions 501, for determining the probabilities of possible routes between an origin “O” to a destination “D” and respective cost values (e.g., ETAs.). In one instance, the machine learning system 123 can continuously provide and/or update a machine learning route model using, for instance, supervised deep convolution networks or equivalents.

In step 409, the output module 307 can providing the recommended route and departure time combination as an output tom for example, a transportation logistics service, such as package delivery, food delivery, product delivery, etc.), a tourism logistics service, a commuting logistics service (e.g., school buses logistics, company shuttle logistics, etc.), etc.

In one embodiment, the output module 307 may provide the output to a vehicle 101, a user of the vehicle 101 (e.g., a driver or a passenger), or a combination thereof via a UE 109 (e.g., an embedded navigation system, a mobile device, etc.) and/or an application 111 running on the UE 109 (e.g., a navigation application). FIG. 9 is a diagram of an example user interface 900 depicting a recommended route and departure time combination, according to one embodiment. By way of example, the system 100 can factor in recurring congestion near the destination around 4:15 in ETA calculation. The user interface 900 shows a current time 3:03, a recommended route 901 between an original and a destination, a notification 903 of a travel time “1 hr 15 min.” The user interface 900 also shows a notification 905 of a “recurring congestion near the destination, and a notification 907 of a “Depart 3:33 with ETA 4:48” of a recommend departure time and the respective ETA.

In one embodiment, the output module 307 can provide the recommended route and departure time combination as part of the input for training the machine learning model. In another embodiment, the output module 307 can output the recommended route and departure time combination to the geographic database 115 for future use, to improve the speed and accuracy of the ETA processes of the transportation logistics platform 105.

The above-discussed embodiments improve ETA and routing services for transportation logistics use cases. With multiple cost models and global TL SPaT data acquired from third parties or government agencies, the above-discussed embodiments can be scaled up worldwide. By monitoring the transportation network and leveraging high-definition map data with road attributes, location-based services (e.g., map matching, routing, navigation, etc.), real-time traffic data (e.g., traffic, incidents, etc.), weather information, advanced analytics capabilities for historical pattern, congestion pattern, etc., traffic light SPaT information, road closure and construction information, etc., the above-discussed embodiments can update small changes of that affect the network in ETA calculation a real-time manner thereby providing efficient and economic route planning while the vehicle travels along a route.

Returning to FIG. 1, in one embodiment, the transportation logistics platform 105 has connectivity over the communication network 107 to the services platform 117 (e.g., an OEM platform) that provides one or more services 119a-119n (also collectively referred to herein as services 119) (e.g., probe and/or sensor data collection services). By way of example, the services 119 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 117 uses the output (e.g. lane-level dangerous slowdown event detection and messages) of the transportation logistics platform 105 to provide services such as navigation, mapping, other location-based services, etc.

In one embodiment, the transportation logistics platform 105 may be a platform with multiple interconnected components. The transportation logistics platform 105 may include multiple servers, intelligent networking devices, computing devices, components and corresponding software for providing parametric representations of lane lines. In addition, it is noted that the transportation logistics platform 105 may be a separate entity of the system 100, a part of the services platform 117, a part of the one or more services 119, or included within the vehicles 101 (e.g., an embedded navigation system).

In one embodiment, content providers 121a-121m (also collectively referred to herein as content providers 121) may provide content or data (e.g., including probe data, sensor data, etc.) to the transportation logistics platform 105, the UEs 109, the applications 111, the probe database 113, the geographic database 115, the services platform 117, the services 119, and the vehicles 101. The content provided may be any type of content, such as map content, textual content, audio content, video content, image content, etc. In one embodiment, the content providers 121 may provide content that may aid in localizing a vehicle path or trajectory on a lane of a digital map or link. In one embodiment, the content providers 121 may also store content associated with the transportation logistics platform 105, the probe database 113, the geographic database 115, the services platform 117, the services 119, and/or the vehicles 101. In another embodiment, the content providers 121 may manage access to a central repository of data, and offer a consistent, standard interface to data, such as a repository of the geographic database 115.

By way of example, the UEs 109 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 109 can support any type of interface to the user (such as “wearable” circuitry, etc.). In one embodiment, a UE 109 may be associated with a vehicle 101 (e.g., a mobile device) or be a component part of the vehicle 101 (e.g., an embedded navigation system). In one embodiment, the UEs 109 may include the transportation logistics platform 105 to provide a recommended route and departure time combination based on real-time estimated times of arrival.

In one embodiment, as mentioned above, the vehicles 101, for instance, are part of a probe-based system for collecting probe data and/or sensor data for detecting traffic incidents (e.g., dangerous slowdown events) and/or measuring traffic conditions in a road network. In one embodiment, each vehicle 101 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 101 may include sensors 103 for reporting measuring and/or reporting attributes. The attributes can also be any attribute normally collected by an on-board diagnostic (OBD) system of the vehicle 101, and available through an interface to the OBD system (e.g., OBD II interface or other similar interface).

The probe points can be reported from the vehicles 101 in real-time, in batches, continuously, or at any other frequency requested by the system 100 over, for instance, the communication network 107 for processing by the transportation logistics platform 105. The probe points also can be map matched to specific road links stored in the geographic database 115. In one embodiment, the system 100 (e.g., via the transportation logistics platform 105) can generate probe traces (e.g., vehicle paths or trajectories) from the probe points for an individual probe so that the probe traces represent a travel trajectory or vehicle path of the probe through the road network.

In one embodiment, as previously stated, the vehicles 101 are configured with various sensors (e.g., vehicle sensors 103) for generating or collecting probe data, sensor data, related geographic/map data, etc. In one embodiment, the sensed data represents sensor data associated with a geographic location or coordinates at which the sensor data was collected. In one embodiment, the probe data (e.g., stored in the probe database 113) includes location probes collected by one or more vehicle sensors 103. By way of example, the vehicle sensors 103 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 101, switch sensors for determining whether one or more vehicle switches are engaged, and the like. Though depicted as automobiles, it is contemplated the vehicles 101 can be any type of vehicle manned or unmanned (e.g., cars, trucks, buses, vans, motorcycles, scooters, drones, etc.) that travel through road segments of a road network.

Other examples of sensors 103 of the vehicle 101 may include light sensors, orientation sensors augmented with height sensors and acceleration sensor (e.g., an accelerometer can measure acceleration and can be used to determine orientation of the vehicle), tilt sensors to detect the degree of incline or decline of the vehicle 101 along a path of travel (e.g., while on a hill or a cliff), moisture sensors, pressure sensors, etc. In a further example embodiment, sensors 103 about the perimeter of the vehicle 101 may detect the relative distance of the vehicle 101 from a physical divider, a lane line of a link or roadway, the presence of other vehicles, pedestrians, traffic lights, potholes and any other objects, or a combination thereof. In one scenario, the vehicle sensors 103 may detect weather data, traffic information, or a combination thereof. In one embodiment, the vehicles 101 may include GPS or other satellite-based receivers 103 to obtain geographic coordinates from satellites 125 for determining current location and time. Further, the location can be determined by visual odometry, triangulation systems such as A-GPS, Cell of Origin, or other location extrapolation technologies.

In one embodiment, the UEs 109 may also be configured with various sensors (not shown for illustrative convenience) for acquiring and/or generating probe data and/or sensor data associated with a vehicle 101, a driver, other vehicles, conditions regarding the driving environment or roadway, etc. For example, such sensors may be used as GPS receivers for interacting with the one or more satellites 125 to determine and track the current speed, position and location of a vehicle 101 traveling along a link or roadway. In addition, the sensors may gather tilt data (e.g., a degree of incline or decline of the vehicle during travel), motion data, light data, sound data, image data, weather data, temporal data and other data associated with the vehicles 101 and/or UEs 109. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via communication network 107 as probe data (e.g., GPS probe data) according to any known wireless communication protocols. For example, each UE 109, application 111, user, and/or vehicle 101 may be assigned a unique probe identifier (probe ID) for use in reporting or transmitting said probe data collected by the vehicles 101 and/or UEs 109. In one embodiment, each vehicle 101 and/or UE 109 is configured to report probe data as probe points, which are individual data records collected at a point in time that records telemetry data.

In one embodiment, the transportation logistics platform 105 retrieves aggregated probe points gathered and/or generated by the vehicle sensors 103 and/or the UE 109 resulting from the travel of the UEs 109 and/or vehicles 101 on a road segment of a road network. In one instance, the probe database 113 stores a plurality of probe points and/or trajectories generated by different vehicle sensors 103, UEs 109, applications 111, vehicles 101, etc. over a period while traveling in a monitored area. A time sequence of probe points specifies a trajectory—i.e., a path traversed by a UE 109, application 111, vehicle 101, etc. over the period.

In one embodiment, the communication network 107 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 101, vehicle sensors 103, Transportation logistics platform 105, UEs 109, applications 111, services platform 117, services 119, content providers 121, and/or satellites 125 communicate with each other and other components of the system 100 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

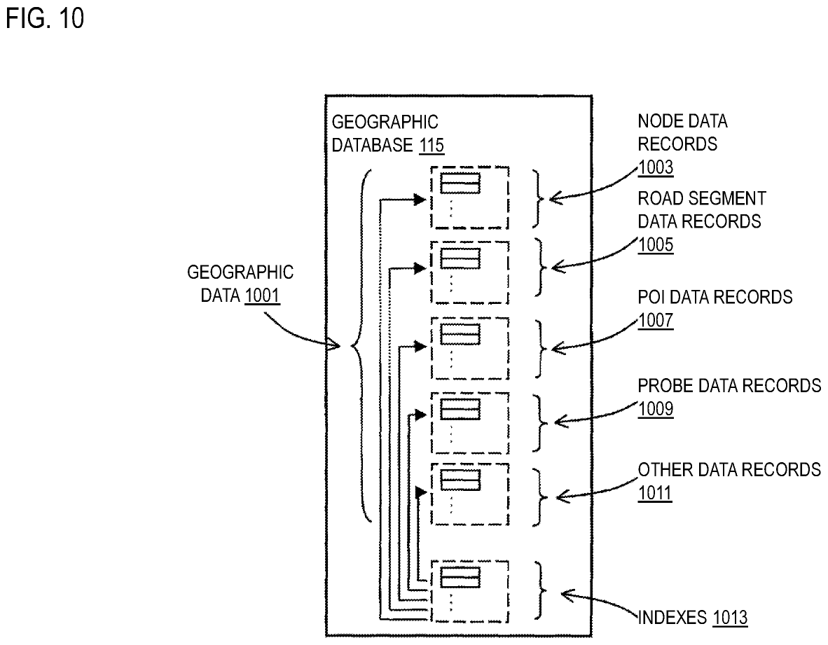

FIG. 10 is a diagram of a geographic database, according to one embodiment. In exemplary embodiments, probe data can be stored, associated with, and/or linked to the geographic database 115 or data thereof. In one embodiment, the geographic database 115 includes geographic data 1001 used for (or configured to be compiled to be used for) mapping and/or navigation-related services, such as for personalized route determination, according to one embodiment. For example, the geographic database 115 includes node data records 1003, road segment or link data records 1005, POI data records 1007, probe data records 1009, other data records 1011, and indexes 1013. More, fewer or different data records can be provided. In one embodiment, the other data records 1011 include cartographic (“carto”) data records, routing data, and maneuver data. In one embodiment, the probe data (e.g., collected from vehicles 101) can be map-matched to respective map or geographic records via position or GPS data associations (such as using known or future map matching or geo-coding techniques), for example. In one embodiment, the indexes 1013 may improve the speed of data retrieval operations in the geographic database 115. The indexes 1013 may be used to quickly locate data without having to search every row in the geographic database 115 every time it is accessed.

In various embodiments, the road segment data records 1005 are links or segments representing roads, streets, paths, or lanes within multi-lane roads/streets/paths as can be used in the calculated route or recorded route information for determination of one or more personalized routes, according to exemplary embodiments. The node data records 1003 are end points corresponding to the respective links or segments of the road segment data records 1005. The road segment data records 1005 and the node data records 1003 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, lane number, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 1007. The geographic database 115 can also include data about places, such as cities, towns, or other communities, and other geographic features, such as bodies of water, mountain ranges, etc. Such place or feature data can be part of the POI data records 1007 or can be associated with POIs or POI data records 1007 (such as a data point used for displaying or representing a position within a city).

In one embodiment, the geographic database 115 can include probe data collected from vehicles 101 (e.g., probe vehicles). As previously discussed, the probe data include probe points collected from the vehicles 101 and include telemetry data from the vehicles 101 can be used to indicate the traffic conditions at the location in a roadway from which the probe data was collected. In one embodiment, the probe data can be map-matched to the road network or roadways stored in the probe database 113, the geographic database 115, or a combination thereof In one embodiment, the probe data can be further map-matched to individual lanes (e.g., any of the travel lanes, shoulder lanes, restricted lanes, service lanes, etc.) of the roadways for subsequent processing according to the various embodiments described herein. By way of example, the map-matching can be performed by matching the geographic coordinates (e.g., longitude and latitude) recorded for a probe-point against a roadway or lane within a multi-lane roadway corresponding to the coordinates.

The geographic database 115 can be maintained by a content provider 121 in association with the services platform 117 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used. In one embodiment, the data can include incident reports which can then be designated as ground truths for training a machine learning classifier to classify a traffic from probe data. Different sources of the incident report can be treated differently. For example, incident reports from municipal sources and field personnel can be treated as ground truths, while crowd-sourced reports originating from the general public may be excluded as ground truths.

The geographic database 115 can be a master geographic database stored in a format that facilitates updating, maintenance, and development. For example, the master geographic database 115 or data in the master geographic database 115 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 109, for example. The navigation-related functions can correspond to vehicle navigation, pedestrian navigation, or other types of navigation. The compilation of the mapping and/or probe data to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 115 can be a master geographic database, but in alternate embodiments, the geographic database 115 can represent a compiled navigation database that can be used in or with end user devices (e.g., UEs 109) to provide navigation-related functions. For example, the geographic database 115 can be used with the end user device UE 109 to provide an end user with navigation features. In such a case, the geographic database 115 can be downloaded or stored on the end user device UE 109, such as in applications 111, or the end user device UE 109 can access the geographic database 115 through a wireless or wired connection (such as via a server and/or the communication network 107), for example.

The processes described herein for providing a recommended route and departure time combination based on real-time estimated times of arrival may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

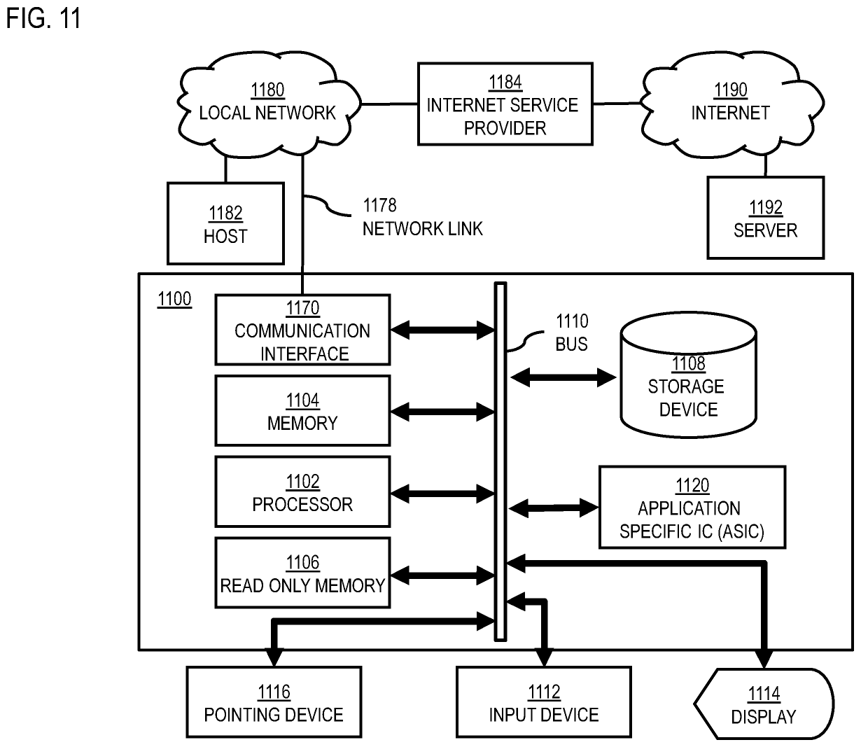

FIG. 11 illustrates a computer system 1100 upon which an embodiment of the invention may be implemented. Computer system 1100 is programmed (e.g., via computer program code or instructions) to provide a recommended route and departure time combination based on real-time estimated times of arrival as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to providing a recommended route and departure time combination based on real-time estimated times of arrival. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or other dynamic storage device, stores information including processor instructions for providing a recommended route and departure time combination based on real-time estimated times of arrival. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing a recommended route and departure time combination based on real-time estimated times of arrival, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 105 for providing a recommended route and departure time combination based on real-time estimated times of arrival to the UE 109 and/or the vehicle 101.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system can be deployed in various configurations within other computer systems, e.g., host 1182 and server 1192.

FIG. 12 illustrates a chip set 1200 upon which an embodiment of the invention may be implemented. Chip set 1200 is programmed to provide a recommended route and departure time combination based on real-time estimated times of arrival as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real-time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to provide a recommended route and departure time combination based on real-time estimated times of arrival. The memory 1205 also stores the data associated with or generated by the execution of the inventive steps.

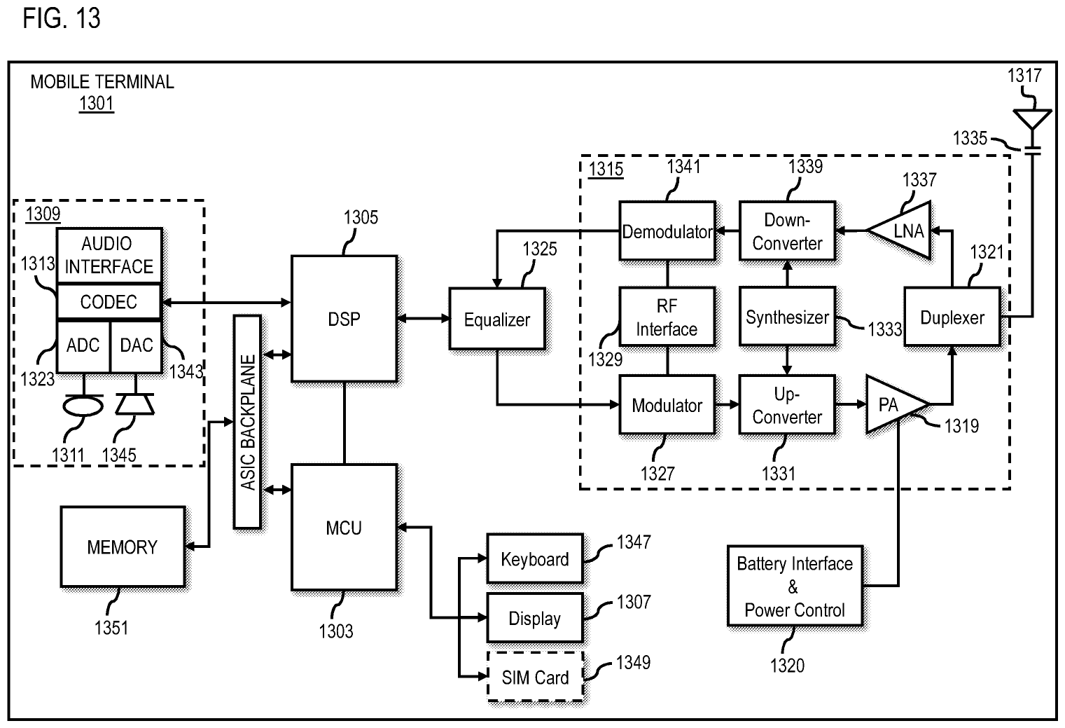

FIG. 13 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile station 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to provide a recommended route and departure time combination based on real-time estimated times of arrival. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile station 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile station 1301 on a radio network. The card 1349 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining a plurality of candidate routes between an origin and at least one destination;
retrieving real-time information, historical information, predicted information, or a combination thereof associated with the origin, the destination, the plurality of candidate routes, or a combination thereof;
calculating respective cost values for traveling for the plurality of candidate routes at a plurality of different departure times, wherein the respective cost values are based on the real-time information, the historical information, the predicted information, or a combination thereof;
determining a recommended route and departure time combination based on the respective cost values; and
providing the recommended route and departure time combination as an output.

2. The method of claim 1, wherein the respective cost values include an estimated time of arrival at the at least one destination.

3. The method of claim 1, wherein the plurality of candidate routes relates to transportation logistics.

4. The method of claim 3, further comprising:
determining a delivery time requirement for the transportation logistics,
wherein the recommended route and departure time combination is further based on the delivery time requirement.

5. The method of claim 4, wherein the delivery time requirement is applied as a constraint on the plurality of departure times, the respective cost values, or a combination thereof.

6. The method of claim 1, wherein the recommended route and departure time combination is determined based on a machine learning model, and wherein the machine learning model accepts the respective cost values as at least one input feature.

7. The method of claim 1, wherein the recommended route and departure time combination is selected based on selecting a minimum cost value from the respective cost values.

8. The method of claim 1, further comprising:
monitoring the real-time information; and
updating the respective cost values based on the real-time information to determine an updated recommended route and departure time combination.

9. The method of claim 1, wherein the real-time information, the historical information, the predicted information, or a combination thereof include traffic light signal phase and timing data.

10. The method of claim 1, wherein the real-time information, the historical information, the predicted information, or a combination thereof relate to recurring congestion data, developing congestion data, predicted congestion data, or a combination.

11. The method of claim 1, wherein the real-time information, the historical information, the predicted information, or a combination thereof relate to high-definition digital map data with lane-level accuracy.

12. The method of claim 1, wherein the recommended route and departure time combination includes a recommended departure delay.

13. An apparatus comprising:
at least one processor; and
at least one memory including computer program code for one or more programs,
the at least one memory and the computer program code configured to, with the at least one processor, cause the apparatus to perform at least the following,
determine a plurality of candidate routes between an origin and at least one destination;
retrieve real-time information, historical information, predicted information, or a combination thereof associated with the origin, the destination, the plurality of candidate routes, or a combination thereof;
calculate respective cost values for traveling for the plurality of candidate routes at a plurality of different departure times, wherein the respective cost values are based on the real-time information, the historical information, the predicted information, or a combination thereof;
determine a recommended route and departure time combination based on the respective cost values; and
provide the recommended route and departure time combination as an output

14. The apparatus of claim 13, wherein the respective cost values include an estimated time of arrival at the at least one destination.

15. The apparatus of claim 13, wherein the plurality of candidate routes relates to transportation logistics.

16. The apparatus of claim 15, wherein the apparatus is further caused to:
determine a delivery time requirement for the transportation logistics,
wherein the recommended route and departure time combination is further based on the delivery time requirement.

17. The apparatus of claim 13, wherein the delivery time requirement is applied as a constraint on the plurality of departure times, the respective cost values, or a combination thereof.

18. A non-transitory computer-readable storage medium, carrying one or more sequences of one or more instructions which, when executed by one or more processors, cause an apparatus to at least perform the following steps:
determining a plurality of candidate routes between an origin and at least one destination;
retrieving real-time information, historical information, predicted information, or a combination thereof associated with the origin, the destination, the plurality of candidate routes, or a combination thereof;
calculating respective cost values for traveling for the plurality of candidate routes at a plurality of different departure times, wherein the respective cost values are based on the real-time information, the historical information, the predicted information, or a combination thereof;
determining a recommended route and departure time combination based on the respective cost values; and
providing the recommended route and departure time combination as an output.

19. The non-transitory computer-readable storage medium of claim 18, wherein the respective cost values include an estimated time of arrival at the at least one destination.

20. The non-transitory computer-readable storage medium of claim 18, wherein the plurality of candidate routes relates to transportation logistics.
